(19) United States
(12) Patent Application Publication
(10) Pub. No.: US 2013/0271998 A1
(43) Pub. Date: Oct. 17, 2013

(54) LED LIGHT BULB AND UNIVERSAL PLATFORM

(71) Applicants: ADI MERSCHON, New Almaden, CA (US); PAUL JUAN, Taipei (TW)

(72) Inventors: ADI MERSCHON, New Almaden, CA (US); PAUL JUAN, Taipei (TW)

(21) Appl. No.: 13/915,584

(22) Filed: Jun. 11, 2013

Related U.S. Application Data
(63) Continuation-in-part of application No. 13/661,955, filed on Oct. 26, 2012.

(30) Foreign Application Priority Data
Oct. 21, 2010 (TW) 99135907A

(51) Int. Cl. F21V 29/00; F21V 13/02; F21V 17/00; F21V 7/00

(52) U.S. Cl. CPC F21V 29/2206; F21V 29/004; F21V 7/00; F21V 13/02; F21V 17/00
USPC 362/294; 362/382; 29/825; 29/829

(57) ABSTRACT

A universal platform may be used to create a family of LED light bulbs with lower costs. One universal platform includes a lamp base, a lamp holder, and a driver. Different upper bulb portions may be assembled on this universal platform. An alternate universal platform include a lamp base, a lamp holder, a heat sink, a driver shell, a driver, a PCB, and one or more LEDs. Different diffusers may be connected to this platform to produce different bulb designs. The bulbs may include an optional diffuser for producing omnidirectional light.

### RELATED APPLICATIONS

This application is a continuation-in-part of co-pending non-provisional patent application U.S. Ser. No. 13/661,955, filed on Oct. 26, 2012; which is a continuation of non-provisional patent application U.S. Ser. No. 13/010,746, filed on Jan. 20, 2011, now U.S. Pat. No. 8,317,372; which claims priority to foreign patent application TW99135907A, filed on Oct. 21, 2010. The entire contents of the aforementioned patent(s) and patent application(s) are herein incorporated by reference.

### BACKGROUND

1. Field of the Invention

The present invention relates to light emitting diode (LED) bulbs, and more particularly, to an LED bulb having a heat dissipating structure disposed therein.

2. Description of Related Art

Since LEDs have advantages of long lifetime, low power consumption and short response time and do not have idling time, the application of the LEDs is increasingly expanded. Particularly, white LEDs are being widely adopted in lighting applications, and conventional halogen or incandescent bulbs are being replaced by the LEDs so as to meet the energy saving and carbon reducing trend.

FIG. 1 is a perspective view of an LED bulb disclosed by Taiwan Utility Model Patent No. M389826. Referring to FIG. 1, the LED bulb 1 comprises a light-transmittable cover 11 with a globe shape, a base 12, and an electrical contact 13. A plurality of light source circuit components, such as LEDs, a circuit board and a transformer (not shown), is disposed inside the base 12 and the cover 11. A heat dissipating structure comprising a plurality of fins 120 each having a plurality of heat dissipating holes 121 is disposed around the periphery of the base 12 such that heat generated by the light source circuit components can be dissipated to the outside through the fins 120. The heat dissipating effect can further be improved by convection through the heat dissipating holes 121.

However, since heat is generated inside the bulb while the heat dissipating structure of the bulb is disposed around the periphery of the base 12 and thermal convection through the heat dissipating holes 121 only reaches the surface of the base 12, the heat cannot be effectively and rapidly dissipated by the heat dissipating structure, thus resulting in high temperature of the bulb. Further, the high temperature of the bulb can adversely affect the light emitting efficiency of the LEDs, cause rapid deterioration of the circuit board, and shorten the lifetime of the bulb.

Therefore, it is imperative to provide an LED bulb with improved heat dissipating efficiency so as to increase the light emitting efficiency and lifetime of the LED bulb.

### SUMMARY

One embodiment of the present invention includes a system for an LED light bulb that uses convection cooling to lower an operating temperature of components of the bulb. The system includes a heat sink, a lamp holder, a driver shell, a driver, a printed circuit board (PCB), and a light-emitting diode (LED). The heat sink includes a first ring and a second ring. The first ring has a larger diameter than the second ring. The heat sink also includes two or more fins connecting the first ring to the second ring. The lamp holder is located around the heat sink and includes a top opening and two or more vents. The top opening and the vents define an airflow path that passes over at least one fin of the heat sink. The driver shell is located within the heat sink, and the driver is located within the driver shell. The PCB is connected to the driver and to the heat sink. The PCB is configured to receive electrical power from the driver and to transfer heat to the heat sink. The LED is located on a surface of the PCB and is configured to illuminate when the PCB is receiving electrical power from the driver.

Another embodiment of the present invention includes a method for assembling a universal platform for manufacturing a family of LED light bulb designs. The universal platform results in lower manufacturing costs. The method includes providing a lamp base configured to removably attach to a standard lamp socket. The method includes connecting a lamp holder to the lamp base. The lamp holder is configured to connect to a plurality of upper bulb portions. The method also includes placing a driver within the lamp holder and connecting the driver to the lamp base, which results in a universal platform for assembling a family of LED light bulb designs.

A further embodiment of the present invention includes a method for assembling a universal platform for a family of LED light bulb designs. The method results in lower manufacturing costs. The method includes providing a lamp base configured to removably attach to a standard light bulb socket. The method includes connecting a lamp holder to the lamp base. The lamp holder comprises two or more vents. The method includes placing a heat sink within the lamp holder. The heat sink includes a first ring and a second ring. The first ring has a larger diameter than the second ring. The heat sink also includes two or more fins connecting the first ring to the second ring. The method includes placing a driver shell within the heat sink and placing a driver within the driver shell and connecting the driver to the lamp base. The method includes connecting a PCB to the first ring of the heat sink. The PCB includes at least one LED located on a surface of the PCB. The heat sink, the lamp holder, or both are configured to receive a diffuser. The method results in a universal platform for assembling an LED light bulb.

### BRIEF DESCRIPTION OF THE FIGURES

The detailed description of some embodiments of the present disclosure is made below with reference to the accompanying figures, wherein like numerals represent corresponding parts of the figures.

FIG. 1 (PRIOR ART) shows a perspective view of a conventional LED bulb;

FIGS. 2A and 2B show an exploded view and an assembly view, respectively, of an LED bulb according to the present invention;

FIG. 3 shows a side view of an embodiment of a heat dissipating structure of the LED bulb according to the present invention;

FIG. 4 shows a side view of another embodiment of the heat dissipating structure of the LED bulb according to the present invention;

FIG. 5 shows a perspective view of an additional embodiment of an LED light bulb, according to the present invention;

FIG. 6 shows an exploded view of the additional embodiment of an LED light bulb, according to the present invention;

FIG. 7 shows a section view of the additional embodiment of an LED light bulb taken along line 7-7 in FIG. 5, according to the present invention;

FIG. 8 shows a front view of the additional embodiment of an LED light bulb, according to the present invention;

FIG. 9 shows a perspective view of an alternate embodiment of an LED light bulb, according to the present invention;

FIG. 10 shows a section view of the alternate embodiment of an LED light bulb taken along line 10-10 in FIG. 9, according to the present invention;

FIG. 11 shows an exploded view of the alternate embodiment of an LED light bulb, according to the present invention; and

FIG. 12 shows a front view of the alternate embodiment of an LED light bulb, according to the present invention.

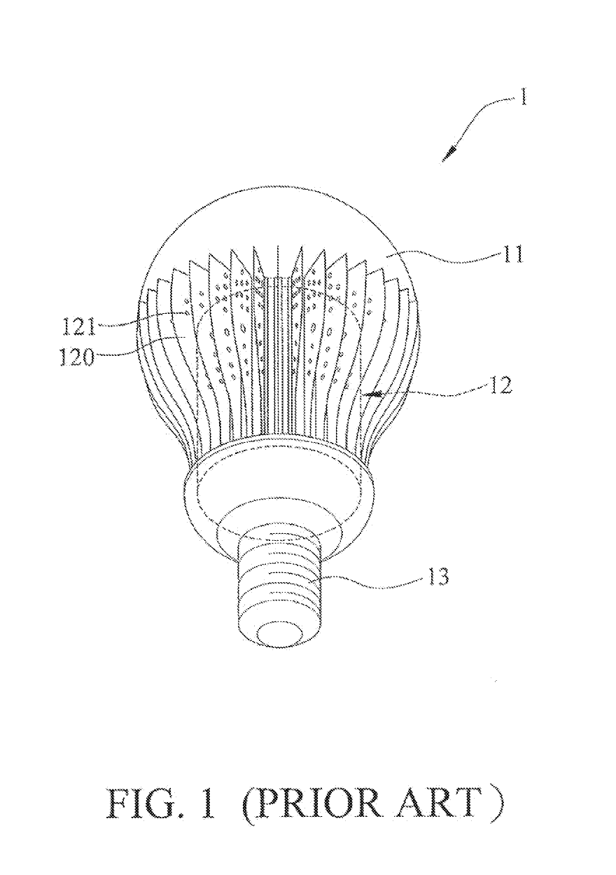

### DETAILED DESCRIPTION OF CERTAIN EMBODIMENTS

The following embodiments are provided to illustrate the present invention. Those skilled in the art will readily understand other advantages and functions of the present invention in accordance with the contents disclosed in this specification.

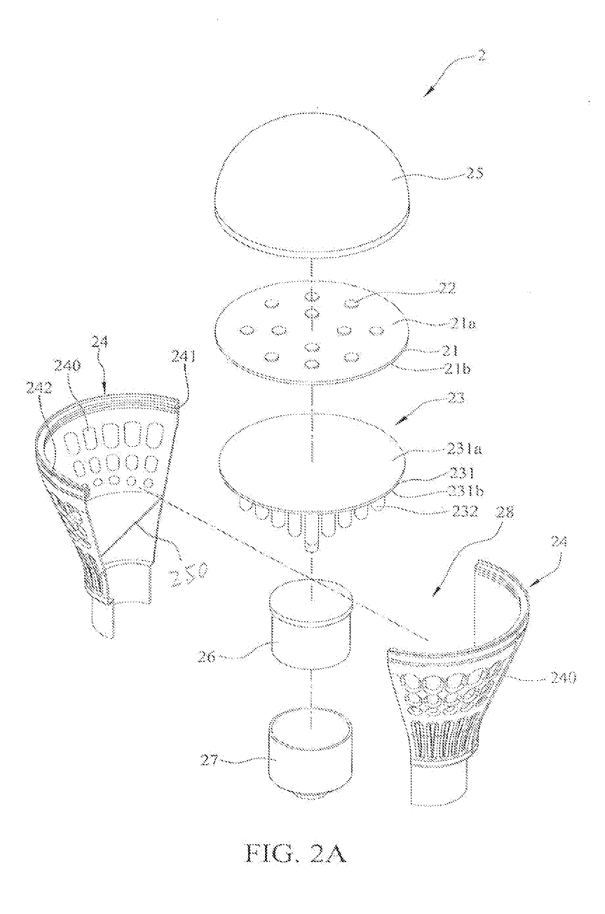

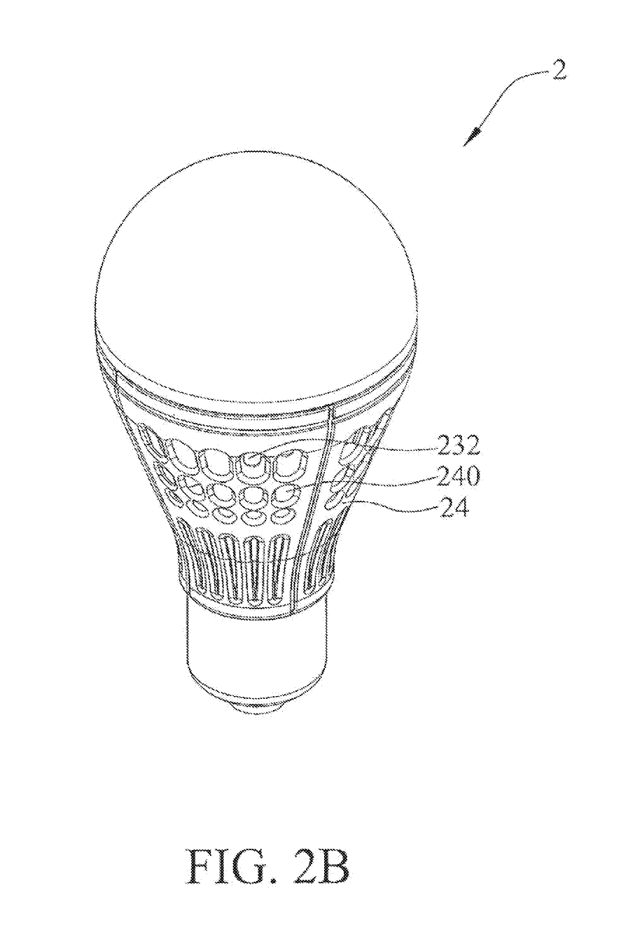

FIGS. 2A and 2B are an exploded view and an assembly view, respectively, of an LED bulb 2 according to the present invention.

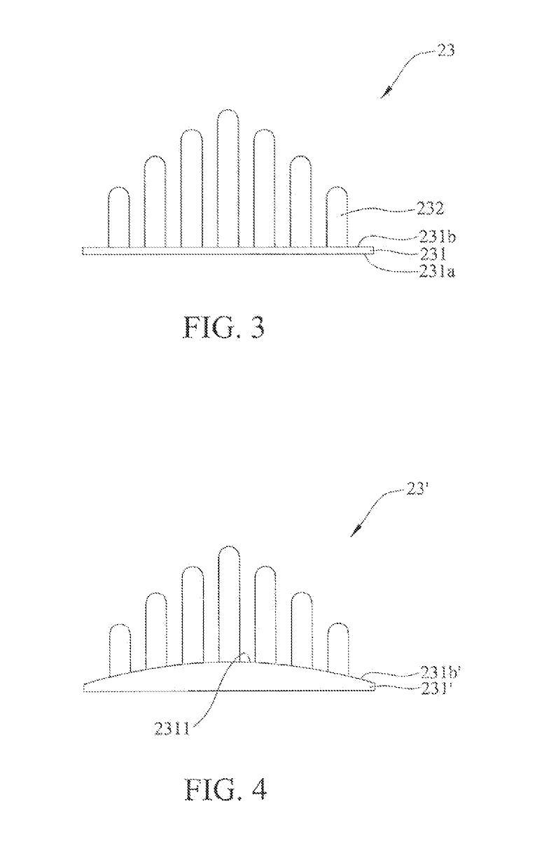

Referring to FIGS. 2A and 2B, the LED bulb 2 comprises: a circuit board 21 having a first surface 21a and a second surface 21b opposite to the first surface 21a; a plurality of LEDs 22 disposed on the first surface 21 a; and a heat dissipating structure 23 comprising a heat dissipating board 231, wherein the heat dissipating board 231 has a third surface 231a and a fourth surface 231b opposite to the third surface 231a, the third surface 231a of the heat dissipating board 231 is attached to the second surface 21b of the circuit board 21, and the fourth surface 23 lb of the heat dissipating board 231 has a plurality of heat dissipating bumps 232 disposed thereon. Further, as shown in FIG. 3, which is a side view of the heat dissipating structure 23, the heat dissipating bumps 232 gradually decrease in length from the center toward the periphery of the fourth surface 231b.

In an embodiment of the present invention, the above-described heat dissipating structure 23 can be formed by die casting.

In an embodiment of the present invention, the above-described LED bulb further comprises a housing 24 disposed around the circuit board 21 and the heat dissipating structure 23, and a plurality of openings 240 is disposed in the housing 24 and positioned around the heat dissipating bumps 232. In particular, a heat dissipating space 28 is formed near the LEDs 22 that generate heat, and the heat dissipating structure 23 is received in the heat dissipating space 28. In an embodiment of the present invention, the heat dissipating structure 23 is preferably made of metal, and the third surface 231 a of the heat dissipating board 231 is attached to the second surface 21b of the circuit board 21 preferably through a thermal paste so as to improve the heat conducting efficiency.

Referring to FIG. 2A, the edges of the circuit board 21 and the heat dissipating structure 23 engage with a groove 241 inside the housing 24, and another groove 242 disposed on the outside of the housing 24 engages with the edge of a cover 25, thereby facilitating the assembly of the LED bulb and saving cost. The cover 25, a power driver 26 and an electrical contact 27 shown in FIGS. 2A and 2B can be provided as known in the prior art, and accordingly detailed description thereof is omitted herein.

According to the above-described structure, heat generated by the circuit board 21 and the LEDs 22 is conducted to the heat dissipating bumps 232 of the heat dissipating structure 23. Since the heat dissipating bumps 232 located in the center of the heat dissipating structure 23 are longer than the heat dissipating bumps 232 located around the periphery of the heat dissipating structure 23, the heat dissipating bumps 232 located in the center of the heat dissipating structure 23 have a larger heat dissipating area for effectively dissipating heat in the center of the circuit board 21, and the shorter heat dissipating bumps 232 located around the periphery of the heat dissipating structure 23 will not block the flow of air in the center. As such, heat in the center can be rapidly dissipated by the heat dissipating bumps 232 through air convection. Furthermore, the openings 240 disposed in the housing 24 cause hot air to be rapidly dissipated out of the LED bulb 2 in all directions (360 degrees), thereby increasing the heat dissipating efficiency.

FIG. 4 shows another embodiment of the heat dissipating structure according to the present invention. For purpose of simplification, only the difference of the present embodiment from the previous embodiment of FIG. 3 is described herein. Referring to FIG. 4, the heat dissipating board 231′ of the heat dissipating structure 23′ has a protruding portion 2311 with a height gradually decreasing from the center toward the periphery of the fourth surface 231b′ so as to increase the heat dissipating area.

In the LED bulb of the present invention, the heat dissipating bumps 232 can have, but not limited to, a triangular pyramid shape, a square pyramid shape, a polygonal pyramid shape, a triangular tapered column shape, a square tapered column shape, a polygonal tapered column shape, a round column shape, a square column shape or a polygonal column shape.

In addition, the present invention can comprise a nano-scaled radiation coating that is disposed on heat dissipating bumps 232 through spray coating, for example, so as to further improve the heat dissipating efficiency.

Therefore, the housing of the LED bulb of the present invention has a heat dissipating space formed near the LEDs that generate heat for receiving a heat dissipating structure, wherein the heat dissipating structure comprises a heat dissipating board having one surface attached to the circuit board having the LEDs and the other surface having a plurality of heat dissipating bumps disposed thereon and gradually decreasing in length from the center toward the periphery of the heat dissipating board. The heat dissipating bumps that gradually decrease in length from the center toward the periphery of the heat dissipating board facilitate rapid dissipation of hot air in the center and the openings disposed around the heat dissipating structure also help to dissipate heat. Further, the heat dissipating space, the heat dissipating bumps and the openings disposed in the housing facilitate thermal convection. As such, the overall heat dissipating effect is improved so as to maintain the LED bulb at a normal temperature, thereby increasing the light emitting efficiency and lifetime of the LED bulb.

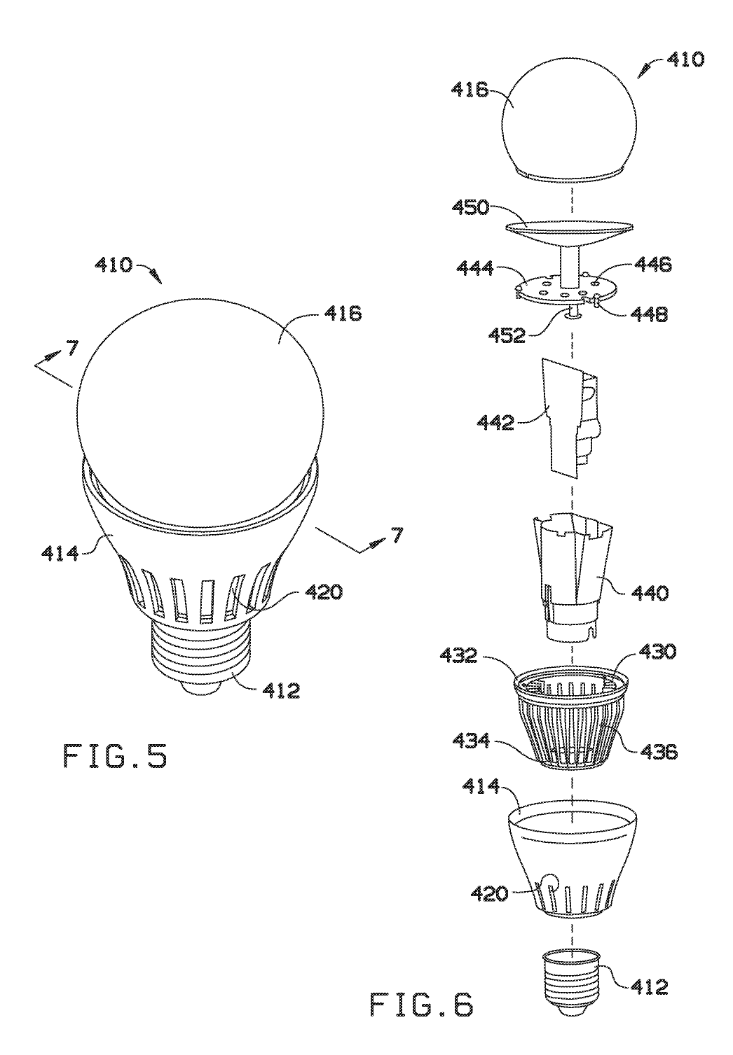

By way of example, and referring to FIGS. 5, 6, and 7, one embodiment of the present invention includes an LED light bulb 410. The bulb 410 may include a lamp base 412, a lamp holder 414, and a diffuser 416. The lamp base 412 may be configured to connect to a standardized light bulb socket, which are well known in the art.

The lamp holder 414 may connect to the lamp base 412. The lamp holder 414 may have an inverted frustoconical shape. The shape may be roughly frustoconical as the shape of the holder 414 may include curves, changes in slope, or other aesthetic modifications. The holder 414 may have one or more vents 420, which may be positioned around the lower portion of the holder 414, near the lamp base 412.

The lamp holder 414 may be made from, e.g., plastic, which may offer many benefits over traditional materials used for LED light bulbs. Plastic may have a lighter weight, which may lower shipping costs per bulb. Plastic may be non-conductive, increasing safety. Plastic may be more resistant to breakage, which may reduce the cost of package and the amount of breakage during shipping and storage.

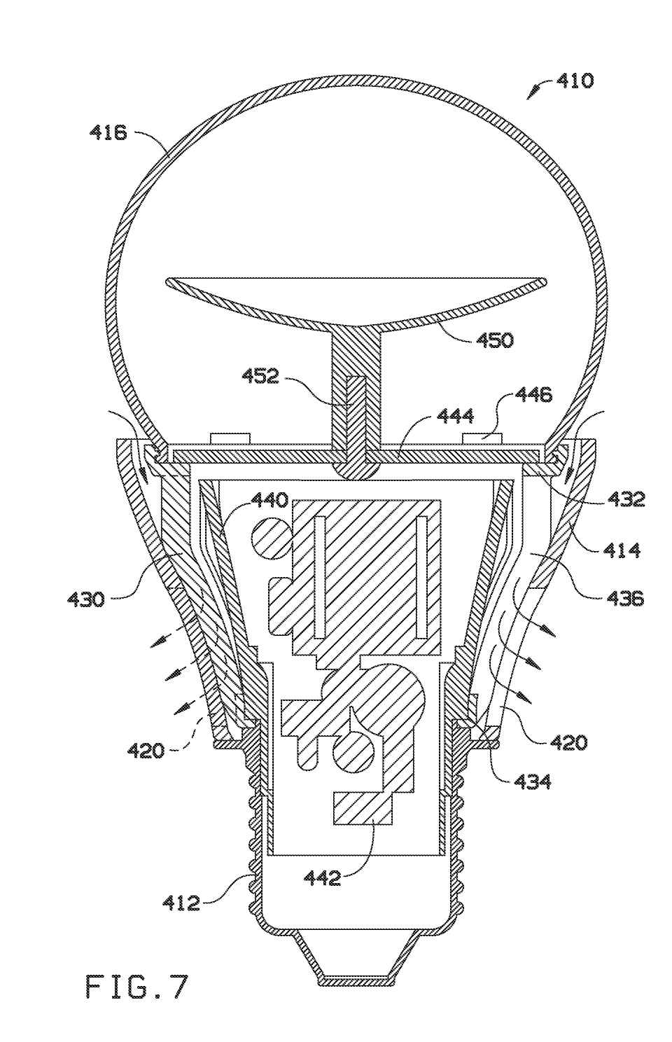

A heat sink 430 may be located inside the lamp holder 414. The heat sink 430 may be made from aluminum or any other suitable material. The heat sick 430 may include an upper ring 432 and a lower ring 434, which may have a smaller diameter than the upper ring 432. The upper ring 432 may be connected to the lower ring 434 by a number of fins 436. The fins 436 may be broader where they connect to the upper ring 432 and may taper to a narrower width where they connect to the lower ring 434. The tapered shape may result in a uniform separation between any two fins 436 over their entire length from the upper ring 432 to the lower 434. The upper ring 432 may have a narrower diameter than the upper opening of the lamp holder 412, creating a small gap or space between the upper ring 432 and the lamp holder 412. In the lower portion of the holder 412, the fins 436 and/or lower ring 434 may contact the holder 412. The gaps between the fins 436 may be aligned with the vents 420 in the holder 412. The holder 412 and the heat sink 430 may define an airflow path from the gap at the top of the holder 412, along the fins 436, and exiting through the vents 420. An exemplary airflow is illustrated in FIG. 7 by the arrows entering at the top of the holder 412 and exiting through the vents 420. For a bulb 410 installed in an inverted or upside-down position, this airflow may be reversed. For a bulb 410 installed in a sideways or horizontal orientation, hot air may exit through the vents 420 on the upper portion of the lamp holder 412 and through the upper portion of the gap between the holder 412 and the heat sink 430. Cooler ambient air may be drawn in through the vents 420 on the lower portion of the holder 412 and through the lower portion of the gap between the holder 412 and the heat sink 430. Thus, there may be a passive convection cooling airflow over the heat sink 430 whether the bulb 410 is installed in a vertical position, and inverted position, a horizontal position, or any angle or position in between.

A driver shell 440 may be located in the center region of the heat sink 430, and a driver 442 may be located within the driver shell 440. The shell 440 may provide electrical and/or thermal insulation for the driver 442, so that the temperature driver 442 is minimally affected by the temperature outside the shell 440. The driver 442 may include any electronics that are necessary to drive or power one or more light-emitting diodes (LED), such as those described below. Such electronics are well known in the art. The driver 442 may be electrically connected to the lamp base 412 and may provide electrical power to a printed circuit board (PCB) 444. One or more LEDs 446 may be connected to the PCB 444 and may provide an illumination source for the bulb 410. The PCB 444 may be cooled by the heat sink 430. For example, the PCB 444 may physically contact the upper ring 432 of the heat sink 430. The PCB 444 may be attached to the upper ring 432 by one or more screws 448. A reflector 450 may be connected to the PCB 444 by a screw 452 or other suitable means. The reflector 450 may be partially transparent such that some light is reflecting and other light is refracted. Thus, the reflector may create a relatively even and omnidirectional light pattern from the relatively directional light created by the LEDs 446. A diffuser 416 may be placed over the PCB 444 and the reflector 450. For example, the diffuser 416 may be connected to the upper ring 432 of the heat sink 430. The diffuser 416 may further enhance the omnidirectional quality of the light from the bulb 410.

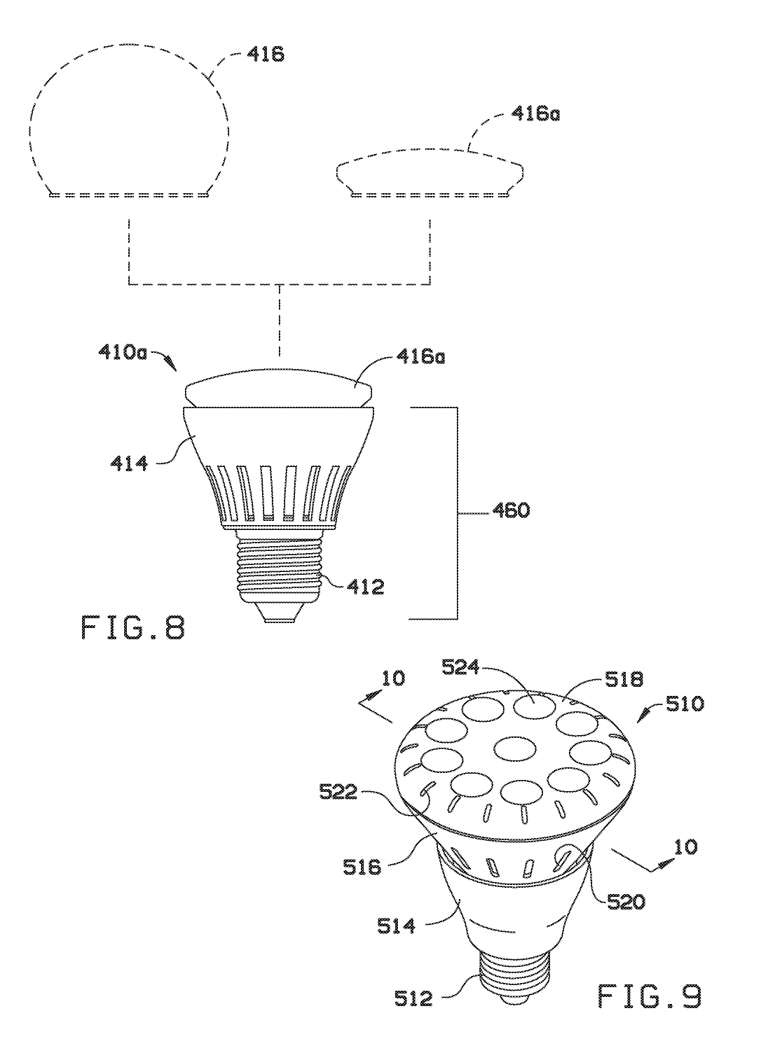

Referring to FIG. 8, the lower portion of the light bulb 410 may serve as a universal platform 460 for a family of LED light bulbs, 410, 410a. The universal platform 460 may include the lamp base 412, the lamp holder 414, heat sink 430, driver shell 440, driver 442, PCB 444, LEDs 446, and related components. Alternative diffuser 416a may be designed to mate to the universal platform 460 in place of diffuser 416 without the need for retooling or any changes in design. For example, by omitting the reflector 450 and reflector screw 452 and replacing diffuser 416 with diffuser 416a, a new light bulb 410a may be assembled using the same base or universal platform 460 as light bulb 410. Light bulb 410a may be a directional light bulb, in contrast to the omnidirectional light bulb 410.

The use of a universal platform 460 in creating a family of light bulbs 410, 410a offers many potential benefits. The design time for the family of bulbs may be much shorter, as only the unique components of each new bulb need to be created. Similarly, the certification process may be shorter and less expensive, as only the new or unique components may need certification once the universal platform has been certified. Tooling costs may be lower, and the time-to-market may be shorter.

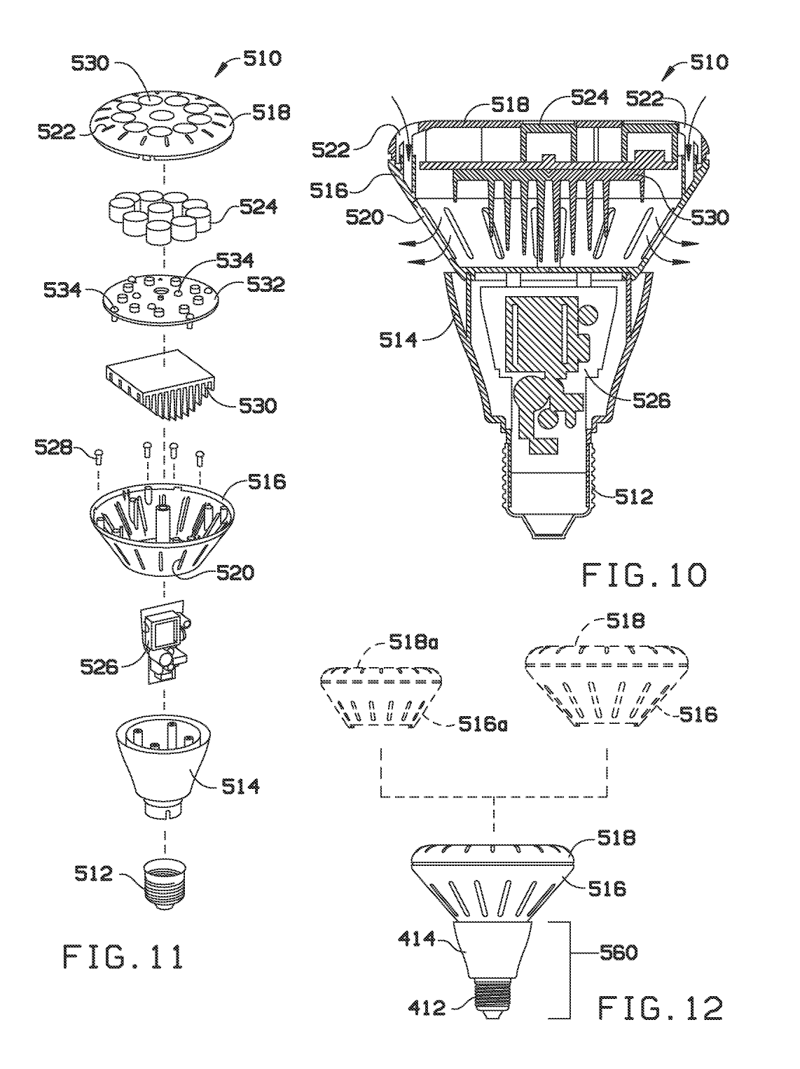

Referring to FIGS. 9, 10, and 11, an alternative LED light bulb 510 design is shown, which is similar in many respects to the bulb 2 shown in FIGS. 2A and 2B. The light bulb 510 includes a lamp base 512, a lamp holder 514, a lower diffuser 516, and an upper diffuser 518. The lower diffuser may include one or more vents 520, and the upper diffuser may include one or more vents 522. The bulb 510 may include one or more lenses 524, and each lens may be associated with one or more LEDs 526. The upper diffuser 518 may include one or more holes 530 for receiving the lenses 524.

The lamp base 512 may be configured to connect to a standardized light bulb socket. The lamp holder 514 may be connected to the lamp base 512. A driver 526 may be located in the lamp holder 514. The lower diffuser 516 may be connected to the lamp holder 514 by one or more screws 528. A heat sink 530 may be located within the lower diffuser 516. The heat sink 530 may be connected to a PCB 532. The LEDs 526 may be connected to and/or located on the PCB 532. The PCB 532 may be connected to the heat sink 530 and/or the lower diffuser by one or more screws 534. The vents 520 and vents 522 may define or create an airflow path for cooling the heat sink 530 by convection cooling. The LEDs 526 may sealed and separate from the airflow due to the lenses 524 and other design parameters. Other components, such as the PCB 532 and driver 526, may be sealed from the environment. Thus, the light 510 may be rated, approved, and/or effective for outdoor use.

Referring to FIG. 12, the lamp base 512, lamp holder 514, and driver 526 may be combined in a universal platform 560 for a family of LED light bulbs. The universal platform may be connected to one of a variety of upper bulb portions. For example, alternate lower diffuser 516a and upper diffuser 518a may be used to create a different light bulb 510a on the same base or universal platform 560. The alternate diffusers 516a, 518a may include their own PCB, LEDs, lenses, and so on (not shown).

The above-described descriptions of the detailed embodiments are intended to illustrate the preferred implementation according to the present invention but are not intended to limit the scope of the present invention. Accordingly, all modifications and variations completed by those with ordinary skill in the art should fall within the scope of present invention defined by the appended claims.

Persons of ordinary skill in the art may appreciate that numerous design configurations may be possible to enjoy the functional benefits of the inventive systems. Thus, given the wide variety of configurations and arrangements of embodiments of the present disclosure the scope of the present disclosure is reflected by the breadth of the claims below rather than narrowed by the embodiments described above.

What is claimed is:

1. A system for an LED light bulb using convection cooling to lower an operating temperature of components of the bulb, the system comprising:
a heat sink comprising an first ring and a second ring, the first ring comprising a larger diameter than the second ring, the heat sink further comprising a plurality of fins connecting the first ring to the second ring;
a lamp holder disposed around the heat sink, the lamp holder comprising a top opening and a plurality of vents, the top opening and the vents defining an airflow path, the airflow path passing over a fin of the heat sink;
a driver shell disposed within the heat sink;
a driver disposed within the driver shell;
a print circuit board (PCB) comprising a surface, the PCB connected to the driver and to the heat sink, the PCB configured to receive electrical power from the driver, the PCB further configured to transfer heat to the heat seat; and
a light-emitting diode (LED) disposed on the surface of the PCB and configured to illuminate when the PCB is receiving electrical power from the driver.

2. The system of claim 1, further comprising:
a lamp base configured to removably attach to a standardized light bulb socket, the lamp base connected to the lamp holder.

3. The system of claim 1, further comprising:
a reflector connected to the PCB and configured to create an even and omnidirectional lighting pattern from directional light generated by the LED.

4. The system of claim 1, further comprising:
a diffuser connected to the heat sink and enclosing the surface of the PCB and the reflector.

5. The system of claim 1, further comprising:
a reflector connected to the PCB and configured to create an even and omnidirectional lighting pattern from directional light generated by the LED; and
a diffuser connected to the heat sink and enclosing the surface of the PCB.

6. A method for assembling a universal platform for assembling a family of LED light bulb designs, the universal platform providing at least lower manufacturing costs, the method comprising:
providing a lamp base configured to removably attach to a standard lamp socket;
connecting a lamp holder to the lamp base, the lamp holder configured to connect to a plurality of upper bulb portions;
placing a driver within the lamp holder and connecting the driver to the lamp base, resulting in a universal platform for assembling a family of LED light bulb designs.

7. The method of claim 6, the upper bulb portion comprising:
a lower diffuser comprising a plurality of vents;
a printed circuit board (PCB) comprising a first surface and a second surface, the PCB connected to the lower diffuser;
a heat sink connected to the second surface of the PCB;
a light-emitting diode (LED) disposed on the first surface of the PCB;
a lens enclosing the LED and connected to the first surface of the PCB; and
an upper diffuser comprising a plurality of vents and a hole configured to receive the lens.

8. A method for assembling an LED light bulb using the universal platform of claim 6, the method comprising:
connecting a lower diffuser to the universal platform, the lower diffuser comprising a plurality of vents;
providing a PCB comprising a first surface, an LED disposed on the first surface, and a second surface;
connecting the second surface of the PCB to a heat sink;
connecting the PCB to the lower diffuser;
enclosing the LED with a lens; and
connecting an upper diffuser to the lower diffuser, the upper diffuser comprising a plurality of vents and a hole configured to receive the lens.

9. A method for assembling a family of LED light bulbs using the universal platform of claim 6, the method comprising:
providing a first universal platform according to claim 6;
connecting a first upper bulb portion to the first universal platform, resulting in a first LED light bulb;
providing a second universal platform according to claim 6; and
connecting a second upper bulb portion to the second universal platform, the second upper bulb portion differing from the first upper bulb portion in at least one feature, resulting in a second LED light bulb, the second LED light bulb differing from the first LED light bulb in at least one feature.

10. The method of claim 9, wherein the feature differing between the first LED light bulb and the second LED light bulb comprises at least one of a size of the lower diffuser, a size of the upper diffuser, a shape of the upper diffuser, a number of LEDs and lenses, and a light output of the LED light bulb.

11. The method of claim 9, further comprising:
providing a third universal platform according to claim 6; and
connecting a third upper bulb portion to the third universal platform, the third upper bulb portion differing from the first upper bulb portion and the second upper bulb portion in at least one feature, resulting in a third LED light bulb, the third LED light bulb differing from the first LED light bulb and the second LED light bulb in at least one feature.

12. The method of claim 11, wherein the feature differing between the first LED light bulb, the second LED light bulb, and the third LED light bulb comprises at least one of a size of the lower diffuser, a size of the upper diffuser, a shape of the upper diffuser, a number of LEDs and lenses, and a light output of the LED light bulb.

13. A method for assembling a universal platform for a family of LED light bulb designs, the universal platform providing at least lower manufacturing costs, the method comprising:
providing a lamp base configured to removably attach to a standard light bulb socket;
connecting a lamp holder to the lamp base, the lamp holder comprising a plurality of vents;
placing a heat sink within the lamp holder, the heat sink comprising a first ring and a second ring, the first ring comprising a larger diameter than the second ring, the heat sink further comprising a plurality of fins connecting the first ring to the second ring;
placing a diver shell within the heat sink;
placing a driver within the driver shell, the driver connected to the lamp base; and
connecting a printed circuit board (PCB) to the first ring of the heat sink, the PCB having a surface, an LED disposed on the surface,
wherein at least one of the heat sink and the lamp holder is configured to receive a diffuser, resulting in a universal platform for assembling an LED light bulb.

14. A method for assembling an LED light bulb using the universal platform of claim 13, the method comprising:
attaching a diffuser to the universal platform.

15. The method of claim 14, further comprising:
attaching a reflector to the PCB.

16. A method for assembling a family of LED light bulbs using the universal platform of claim 13, the method comprising:
providing a first universal platform according to claim 13;
connecting a first diffuser to the first universal platform;
providing a second universal platform according to claim 13; and
connecting a second diffuser to the second universal platform, the second diffuser differing from the first diffuser in at least one feature.

17. The method of claim 16, wherein the feature differing between the first diffuser and the second diffuser is at least one of diffuser size, diffuser shape, and diffuser opacity.

18. The method of claim 16, further comprising:
connecting a reflector to the first universal platform.
